(19) United States
(12) Patent Application Publication
(10) Pub. No.: US 2025/0029610 A1
(43) Pub. Date: Jan. 23, 2025

(54) METHOD FOR OPERATING A SPEECH DIALOGUE SYSTEM

(71) Applicant: MERCEDES-BENZ GROUP AG, Stuttgart (DE)

(72) Inventors: Ute EHRLICH, Blaustein (DE); Jakob ZIMMERMANN, Ulm (DE)

(21) Appl. No.: 18/708,454

(22) PCT Filed: Oct. 14, 2022
(86) PCT No.: PCT/EP2022/078625

§ 371 Date: May 8, 2024

(30) Foreign Application Priority Data
Nov. 9, 2021 (DE) 10 2021 005 546.2

(51) Int. Cl. G10L 15/22; G10L 13/033

(52) U.S. Cl. CPC G10L 15/222; G10L 13/033; G10L 2015/228

(57) ABSTRACT

A method for operating a speech dialogue system involves determining a vehicle context and information relating to the vehicle context and checking whether the information has a validity duration shorter than a predefined reference value and is thus to be graded as urgent. If the information is urgent, it is further checked whether the information has a validity value exceeding a predetermined threshold value for the user. If the threshold value is also exceeded, a speech output adjusted to the current communication status and directed towards a vehicle user is automatically carried out.

### BACKGROUND AND SUMMARY OF THE INVENTION

Exemplary embodiments of the invention relate to a method for operating a speech dialogue system and a speech dialogue system for carrying out the method.

A method is known from the publication US 2014/0136187 A1 in which a speech output is automatically started, taking the vehicle context into consideration. The vehicle context comprises, for example, external temperature, rain, position, or fog. Context-relevant information comprises, for example, instructions to operate the fog lights in the event of emerging foggy conditions.

A method is known from DE 10 2006 060 519 A1 in which information, in particular relating to the vehicle and situation, is evaluated according to certain criteria and, depending on this evaluation, is issued to the driver, preferably at temporally predetermined intervals. Here, the identity of the current driver is ascertained when the vehicle starts, and the information is issued for output to the driver depending on the current driver and a stored information output history of the respective driver.

US 2020/0 357 406 A1 discloses a method in which an output of information to a user is made dependent on various factors. Here, the factors comprise, for example, whether the user is currently speaking, who is sending the information, a degree of importance of the information, a reference to previous information, or preferences of the user.

Exemplary embodiments of the invention are directed to an improved method in contrast, which takes further parameters into consideration along with the context when generating an automatic speech output.

In the method according to the invention, it is checked as to whether a piece of information belonging to the vehicle context is urgent, i.e., is only relevant for a short period of time and has a validity duration of less than a predetermined reference value, and if the information is urgent, it is checked as to whether the information has an importance value for the user lying above a threshold value, wherein, if the threshold value is exceeded, a speech output adjusted to the current communication status is automatically issued to a vehicle user.

The communication status comprises various states of a communication of the speech dialogue system with the vehicle user. In one state, no communication takes place, i.e., the driver and the speech dialogue system do not issue any speech output. In this state, the speech dialogue system is ready to receive and listens out for speech output of the vehicle user. Further states comprise a speech output by the vehicle user or the speech dialogue system.

In terms of the present application, a piece of information is urgent when it belongs to an event happening at a point in time and the piece of information has only a very short validity duration. A reaction to an event must be carried out immediately or at least within a narrow time frame since the piece of information loses relevance after a short period of time and completely loses meaning. The predetermined validity duration defines the scope of urgent information, for example information that loses its validity after 1 s or 5 s can be defined as urgent.

Urgent information is information that is based on current sensor data (visually or also acoustically) at a geographical position. Urgent information relates e.g., to the current traffic situation, a danger zone to be passed or a corresponding traffic sign, overtake request when driving automatically, or a point of interest emerging in the vehicle surroundings.

By contrast, in terms of the present application, a piece of information is important that has a high priority for a vehicle user, i.e., important information is user-specific. For a vehicle user, important information with a corresponding importance value is stored in a user model. Important information can be stored manually and/or learned from user behavior. Important information is generated, for example, from applications such as a navigation system, an appointment diary, an email system. Here, an email from one person can have a greater importance value than from a different person. Importance values of a piece of information can also be situation-dependent, e.g., a user may be interested in tourist information during a holiday trip, but this is not important when driving to work. Preferably, all information about the current traffic situation and the current drive/journey is to be considered important.

All information can have an individual degree of importance, wherein presently only information with a degree of importance lying above a predetermined threshold value, i.e., with a degree of importance lying above a threshold value, is taken into consideration. A piece of urgent information does not have to always be important to a user. For example, a POI is urgent because it is only visible for a few seconds but is not important to a user because there is no interest in this POI. Conversely, there is information that is important to the user that is not urgent. A piece of information of an email of an acquaintance has a high degree of importance, as an example, but is not urgent since the validity duration is very long.

Since, in the understanding of the present application, only urgent and important information is issued acoustically, the vehicle user can advantageously concentrate as best as possible on the driving task.

In an advantageous development, if a communication status is present in which no communication between driver and speech dialogue system is taking place, a first prosodically emphasized speech output is automatically issued by the speech dialogue system to attract attention and produce willingness to listen by the vehicle user. Prosodically emphasized is to be understood as a speech output changed in comparison to a standard one in terms of intonation, volume, duration, speech tempo, rhythm, and/or voice pitch. The attention of the vehicle user is attracted by the emphasized speech output, wherein the speech output is preferably formulated as an interjection formulated as an appeal or greeting and/or salutation by name. Advantageously, the first speech output ensures that the driver does not fail to hear subsequent information.

In a further additional or alternative advantageous development, if a communication status is present in which a speech output of the speech dialogue is taking place, this is interrupted and changed automatically to a second prosodically emphasized speech output introducing a change in topic. In the case of an expiring speech output, this is interrupted, and a second speech output different from the first is accessed, which is clearly differentiated from the speech issued before the pause by the prosodic emphasis and attracts the attention of the vehicle user.

In a further additional or alternative advantageous development, if a communication status is present in which the vehicle user is speaking, a prosodic third speech output is automatically issued for interrupting, attracting attention, and producing readiness to listen of the vehicle user. The third speech output, different from the first and second, is preferably formulated apologetically and pursues the goal of interrupting the flow of speech of the driver and producing readiness to listen.

In a further embodiment, after issuing one of the first, second, or third speech outputs, the reaction of the driver is monitored, wherein depending on the reaction, the further dialogue is formed. The reaction comprises an emotional stirring, a verbal utterance, a gesture, and/or facial expression detected by a camera, as well as neutral behavior in which no reaction following the speech output can be ascertained.

In a further design of the method, if the driver shows no reaction or a negative one, a further speech output is issued that is prosodically strengthened in comparison to the first, the second, or third previous speech outputs. Along with the further speech output, optical and acoustic signals, for example a beep or buzzing, can furthermore be added to increase attention. The further speech output comprises a salutation by name or an appeal. The reaction of the driver is then evaluated again and, depending on the reaction, the further dialogue is adjusted or further measures are introduced. If the vehicle user shows no reaction or a dismissive one, the verbal dialogue is set up and, as needed, a function of the vehicle is started, for example a vehicle stop, a steering intervention or a speed adjustment. If the driver reacts positively, the speech dialogue system issues the urgent information with an importance value lying above the threshold. Advantageously, as a result of the method, only information that the vehicle user also wants is presented to them.

In a further advantageous design, the state of the speech dialogue system and/or the dialogue course up to the interruption is stored and, after issuing the urgent information with an importance value lying above the threshold value, this state is communicated to the user and/or the previous dialogue course is reproduced repeatedly at least partially in a summarized form. If, for example, before the interruption, a dialogue has taken place in which a navigation goal has been issued or the vehicle user has requested a telephone number, then the state of the speech dialogue before the interruption is communicated to the user, i.e., “back to the destination input” or “do you still want to call Mr. Müller?” and the previous speech output and/or input is at least partially repeated. The user can thus continue the activities they started before the interruption without hindrance.

In a development of the method, the importance value of a piece of information is stored in a self-learning user model. It is ascertained from the historical user behavior which information is important or less important. In doing so, inputs into an entertainment system connected to the speech dialogue system and, preferably, to the internet, for example, are evaluated. Frequent actions, such as questions about tourist information or queries about the appointment diary, phone calls to a certain person, increase the importance value of information or information classes related to these actions. Here, the importance value is personalized and even learned depending on the situation or location in a model preferably formed as a neural network.

In one development of the method, an individual validity duration is allocated to each class of information. A piece of information can be differently relevant to a user, for example a warning of a crossing assistant relating to a crossing vehicle, has a very short validity duration, an indication to a point of interest, in contrast, a much longer validity duration. The information classes provided with individual validity values enables a distinction between urgent and non-urgent information as a result of comparison to the pre-defined reference value. In a development, the validity duration of the information classes are dynamically adjusted depending on the vehicle context, i.e., time of day, weather, type and course of the road, speed. For example, at high speed on a motorway, a piece of information pointing out an exit sign has a clearly shorter validity duration than when driving more slowly. A piece of information about a request to take over control of the vehicle to end the autonomous driving operation has a different validity duration when driving on the motorway at a moderate speed to on a fast-moving, winding country road.

In other words, a piece of information can be urgent in one context and non-urgent in a different context, since the validity duration of a piece of information can, depending on context, be shorter or the same or longer in relation to the reference.

The system according to the invention is set up to carry out the method according to one of the previous method steps. The system has sensors for ascertaining the vehicle context and a control unit for ascertaining information relating to the vehicle context. Information about each vehicle context is stored in the control unit, for example. The control unit further ascertains a validity duration belonging to the piece of information and compares this to a pre-defined reference value. If the validity duration is smaller than the reference value, then the piece of information is to be graded as urgent. The control unit further checks whether the piece of information has a validity value exceeding a predetermined threshold value. The importance value further reflects how relevant, in terms of the content, a piece of information is to a user. The importance value of each piece of information is stored in the control device and is preferably adjusted dynamically corresponding to the user behavior. The validity value of a piece of information can mean the same to all users; in an alternative or additional development the importance value is stored personalized in a profile of the vehicle user, i.e., the driver. If the piece of information is urgent and exceeds the threshold value, the control device automatically, i.e., proactively and spontaneously, issues a speech output adjusted to the communication status.

Further advantages, features and details emerge from the description below in which—optionally with reference to the drawings—at least one exemplary embodiment is described in detail. Features described and/or depicted pictorially can form the subject matter of the invention individually or in any meaningful combination, optionally also independently of the claims, and can in particular additionally also be the subject matter of one or more separate application/s. The same, similar and/or functionally identical parts are provided with the same reference numerals.

### BRIEF DESCRIPTION OF THE DRAWING FIGURES

Here are shown:

FIG. 1 method for operating a speech dialogue system and

FIG. 2 a speech dialogue system.

### DETAILED DESCRIPTION

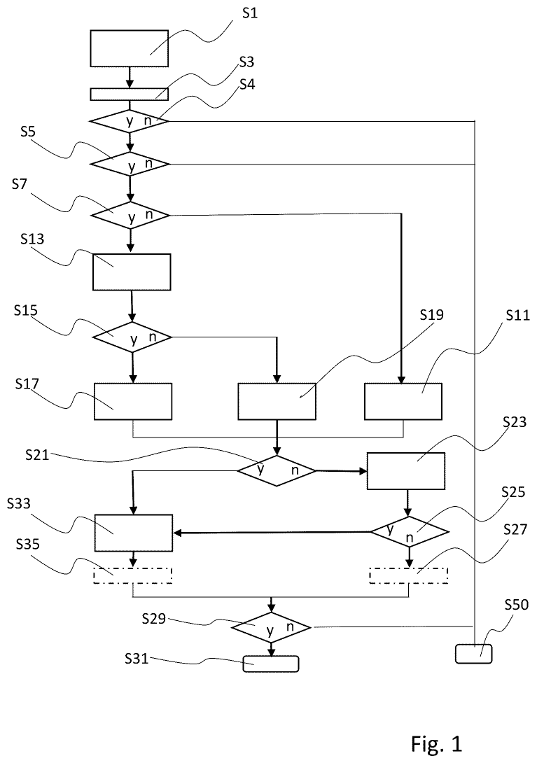

According to FIG. 1, a method for operating a speech dialogue system is depicted in which the vehicle context is ascertained in step S1. The vehicle context comprises, for example, the traffic situation when driving automatically or the situation outside the driving vehicle, i.e., objects, point of interest, people, traffic signs, outside the vehicle, driving lane markings, ends of traffic jams, crossing vehicles, weather conditions, etc. In the next step S3 it is ascertained which information relating to the vehicle context ascertained by sensors for issuing to a driver is stored or can be generated.

It is checked in step S4 as to whether the information belonging to the context is urgent. In addition, it is checked as to whether the validity duration lies below a predetermined reference value. If the validity duration lies below the reference value, the information is urgent and must be issued without delay in order to still be temporally relevant to the vehicle user. If the information is not urgent, no proactive output is started and the method ends in step S50.

If the information is urgent, then the importance is checked in step S5. An importance value repeats the content-related relevance to the vehicle user. A piece of information can be important to one vehicle user and unimportant to another. If the importance value lies below a predetermined threshold value, the proactive output ends in step S50. If the importance value lies above the threshold value, then the information is also of content-related relevance to the vehicle user, and the method is continued in step S7. The communication status is checked in step S7, i.e., whether or not a current speech dialogue takes place. If no dialogue is currently taking place, then a first prosodically emphasized speech output for attracting attention and producing readiness to listen by the vehicle user is carried out automatically in step S11. The first speech output comprises an interjection, i.e., an appeal or greeting and/or a salutation by name with prosodic emphasis, e.g. “Hello!”, “it is important!” or “Mr. Müller”.

If, in step S7, an ongoing speech dialogue is ascertained, then the dialogue is interrupted in step S13, and the dialogue state i.e., type of dialogue and dialogue carried out up to the interruption is stored. The ongoing speech dialogue comprises a speech output of the dialogue system and/or a speech output of the vehicle user, for example a general speech output or one directed towards the dialogue system. A speech output of the user is, for example, directed towards the dialogue system if a mention of a keyword is carried out in advance or it constitutes a response to a speech output of the dialogue system.

In step S15 it is ascertained who has made a speech utterance up until the interruption. If the dialogue system has been actuated at the point in time of the interruption of a speech output, it is automatically changed in step S17 to a second prosodically emphasized speech output introducing a change in topic. The change comprises a speech pause and an interjection including the change in topic, for example “anyway” or “look right”.

If it is established in step S15 that the dialogue system has not actuated a speech output but rather the vehicle user is speaking, then in step S19 a prosodic third speech output is automatically issued for interrupting, attracting attention, and producing readiness to listen of the vehicle user. The interruption preferably comprises an interjection in the form of an apology, for example “Unfortunately I have to interrupt you!”.

After issuing one of the three speech outputs, the reaction of the driver is examined in step S21. A distinction is made between a positive or negative or no reaction. The reaction can comprise, for example, a verbal utterance or even an acknowledgement detected via camera in the form of a gesture and/or a facial expression. A negatory reaction is, for example, a headshake, a wave away with a hand or a dismissive verbal utterance. If no reaction or a negative one can be detected in step S21, i.e., negatory, then in step S23 a further interjection comprising an appeal and/or a salutation by name accompanied by an acoustic signal (beep) with a strengthened prosodic emphasis in comparison to one of the previous three verbal utterances is issued, for example “please listen, this information is very important.”

In step S25, the reaction of the user is examined again; if the reaction remains negative then, depending on information classes, it is changed directly to step S29 or initially to step S27, in which a non-verbal reaction of the vehicle is carried out, for example after an unsuccessful takeover of the vehicle control by the vehicle user, an emergency stop is initiated. If the check in S29 shows that a dialogue state has been stored in S13, then in step S31 this state is communicated to the user and/or a previous dialogue is reproduced repeatedly to the user at least partially in a summarized form. If no dialogue state is stored, the proactive output is ended in step S50.

If the reaction in step S21 is expressed positively, i.e., affirmatively, for example by nodding, smiling, or a verbal utterance, the information is issued in step S33. In the understanding of the present application, information is to be understood as, for example a request, a suggestion, and a piece of information as such, for example relating to a point of interest.

If the vehicle user reacts with a question, a dialogue is held for clarification in optional step S35. If the check in step S29 in turn shows that a dialogue state has been stored in S13, then in step S31 this state is communicated to the user and/or a previous dialogue is reproduced repeatedly to the user at least partially in a summarized form. If no dialogue state is stored, the proactive output is ended in step S50.

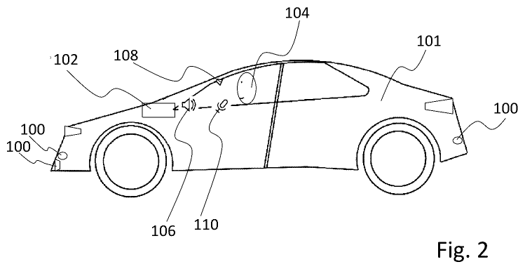

FIG. 2 shows a system set up to carry out the method described above. The system implemented in the motor vehicle 101 has sensors 100 for ascertaining the vehicle context and a control unit 102 for ascertaining information relating to the vehicle context. The sensors 100 are designed, for example, as ultrasonic, radar, or lidar sensors, and/or as a camera. Information is saved in the control unit 102, for example, relating to each vehicle context. The control unit 102 further ascertains a validity duration belonging to the information and compares this to a predefined reference value. If the validity duration is shorter than the reference value, then the control device 102 grades the information as urgent. The control unit 102 further checks whether the information has an importance value exceeding a predetermined threshold value. The importance value gives a content-related relevance of a piece of information for a vehicle user 104. The importance value of each piece of information is stored in the control device 102 and is preferably dynamically adjusted to correspond to the user behavior and the vehicle context. The importance value of a piece of information can be the same size for all users; in an alternative or additional development, the importance value is stored in a personalized manner in the control unit. The system furthermore has speakers 106; if the information is urgent and exceeds the threshold value, the control device 102 automatically, i.e., proactively and spontaneously, issues via the speakers 106 one of the three speech outputs adjusted to the communication status. Speech inputs of the vehicle user 104 are transmitted to the control device 102 via a microphone 110 for evaluation. A reaction of the user to a speech output is ascertained by means of a camera 108 included in the system and the microphone 106.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-12. (canceled)

13. A method for operating a speech dialogue system, the method comprising:
determining a vehicle context;
determining information relating to the vehicle context;
checking whether the information relating to the vehicle context has a validity duration shorter than a predefined reference value and is to be graded as urgent; and
checking, responsive to the information relating to the vehicle context being graded as urgent, whether the information relating to the vehicle context has an importance value exceeding a predetermined threshold value for user,
wherein, responsive to the information relating to the vehicle context having an importance value exceeding the predetermined threshold value for the user, a speech output adjusted to a current communication status is automatically issued to the user.

14. The method of claim 13, wherein, responsive to a communication status being present in which no communication is taking place between the and the speech dialogue system, a first prosodically emphasized speech output is automatically issued to attract attention and produce readiness to listen of the user.

15. The method of claim 14, wherein, responsive to a communication status being present in which a speech output of the speech dialogue system is occurring, the speech output is interrupted and is automatically switched to a second prosodically emphasized speech output introducing a change in topic.

16. The method of claim 15, wherein, responsive to a communication status being present in which the user is speaking automatically, a prosodic third speech output is issued for interrupting, attracting attention, and producing readiness to listen of the user.

17. The method of claim 16, after issuing one of the first, second or third speech outputs, a reaction of the user is monitored.

18. The method of claim 17, wherein, responsive to monitoring of the user not showing the user having any reaction or a negative reaction, a further speech output prosodically strengthened in comparison to the first, the second, or third previous speech outputs is performed.

19. The method of claim 17, wherein, responsive to the monitoring of the user showing the user reacting positively, the speech dialogue system issues the urgent information with an importance value lying above the threshold value.

20. The method of claim 15, wherein a state of the speech dialogue system or a dialogue course until interruption is stored and, after issuing the urgent information with an importance value lying above the threshold value, the state is communicated to the user or reproduced repeatedly to the user at least in a partially summarized form.

21. The method of claim 13, wherein the importance value of information is determined in a self-learning manner from historical user behavior.

22. The method of claim 13, wherein an individual validity value is allocated to each class of information.

23. The method of claim 22, wherein the individual validity value is adjusted depending on the user or the vehicle context.

24. A speech dialogue system configured to:
determine a vehicle context;
determine information relating to the vehicle context;
check whether the information relating to the vehicle context has a validity duration shorter than a predefined reference value and is to be graded as urgent; and
check, responsive to the information relating to the vehicle context being graded as urgent, whether the information relating to the vehicle context has an importance value exceeding a predetermined threshold value for user,
wherein, responsive to the information relating to the vehicle context having an importance value exceeding the predetermined threshold value for the user, a speech output adjusted to a current communication status is automatically issued to the user.
